(19) United States
(12) Patent Application Publication
(10) Pub. No.: US 2023/0312306 A1
(43) Pub. Date: Oct. 5, 2023

(54) SAFETY CHAIN DEVICE AND SAFETY PROTECTION SYSTEM FOR ESCALATOR

(71) Applicant: Otis Elevator Company, Farmington, CT (US)

(72) Inventor: Kun Ma, Shanghai (CN)

(21) Appl. No.: 17/979,433

(22) Filed: Nov. 2, 2022

(30) Foreign Application Priority Data
Mar. 8, 2022 (CN) 202210228155.5

(51) Int. Cl. B66B 5/02; B66B 7/12; B66B 7/06; B66B 1/46; B66B 5/00

(52) U.S. Cl. CPC B66B 5/02; B66B 1/46; B66B 5/0031; B66B 7/066; B66B 7/1223

(57) ABSTRACT

A safety chain device includes a safety chain including a plurality of protective switches connected in series, each of the protective switches is configured to switch from a first state to a second state in the event of abnormal operation of a respective corresponding drive chain; a resistive network encoder having a plurality of encoder output values, each of the encoder output values corresponds to one of combinations of states of the plurality of protective switches; a processor coupled with the resistive network encoder and configured to output a level signal corresponding to the encoder output values; a first controlled current source coupled with the safety chain and configured to output a first current corresponding to a current flowing through the safety chain; and a second controlled current source coupled with the processor and configured to output a second current corresponding to the level signal.

### FOREIGN PRIORITY

This application claims priority to Chinese Patent Application No. 202210228155.5, filed Mar. 8, 2022, and all the benefits accruing therefrom under 35 U.S.C. §119, the contents of which in its entirety are herein incorporated by reference.

### TECHNICAL FIELD

The present application relates to elevator technology, in particular to a safety chain device and a safety protection system for an escalator.

### BACKGROUND

A controller of an escalator is usually connected to a safety chain box through a long signal transmission cable (e.g., over 20 meters). The safety chain box includes a safety chain and a passive resistive network. When on-off states of protective switches forming the safety chain change, the equivalent resistance of the resistive network connected with the safety chain also changes. As a result, the controller can determine the protective switch whose state has changed by sampling the voltage associated with the equivalent resistance, and thus locate a drive chain that has failed. However, a problem that has plagued the industry for a long time is that the signal transmission cable connecting the controller and the safety chain box introduces noise into the transmission signal. When the signal transmission cable is long, a large noise component will cause a wrong safety detection signal to be received at the controller side, leading to misoperation. In addition, the equivalent resistance of the passive resistive network is non-linear, which further increases the difficulty of locating the protective switch whose state has changed.

### SUMMARY

According to an aspect of the present application, there is provided a safety chain device for an escalator, comprising: a safety chain including a plurality of protective switches connected in series, each of the protective switches is configured to switch from a first state to a second state in the event of abnormal operation of a respective corresponding drive chain; a resistive network encoder coupled with the safety chain and having a plurality of encoder output values, each of the encoder output values corresponds to one of the combinations of states of the plurality of protective switches; a processor coupled with the resistive network encoder and configured to output a level signal corresponding to the encoder output values; a first controlled current source coupled with the safety chain and configured to output a first current corresponding to a current flowing through the safety chain; and a second controlled current source coupled with the processor and configured to output a second current corresponding to the level signal.

Optionally, in the above safety chain device, the first state and the second state are a closed state and an open state respectively.

In addition to one or more of the above features, in the above safety chain device, both ends of the safety chain are coupled to a power supply and an input end of the first controlled current source respectively.

In addition to one or more of the above features, in the above safety chain device, the resistive network encoder comprises a plurality of paired input ends, and each of the paired input ends is coupled to both ends of one of the plurality of protective switches.

In addition to one or more of the above features, in the above safety chain device, the first controlled current source and the second controlled current source are current-controlled current sources.

Optionally, in the above safety chain device, the first controlled current source is configured to output a current k times the current flowing through the safety chain when the plurality of protective switches are all in the closed state and to output a zero current when at least one of the plurality of protective switches is in the open state.

Optionally, in the above safety chain device, output ends of the first controlled current source and the second controlled current source are coupled with an external device via a signal transmission cable.

In addition to one or more of the above features, in the above safety chain device, the processor is configured to analyze the states of the protective switches in real time.

According to another aspect of the present application, there is provided a safety protection system for an escalator, comprising: a safety chain device comprising: a safety chain including a plurality of protective switches coupled in series, each of the protective switches is configured to switch from a first state to a second state in the event of abnormal operation of a respective corresponding drive chain; a resistive network encoder having a plurality of encoder output values, each of the encoder output values corresponds to one of combinations of states of the plurality of protective switches; a processor coupled with the resistive network encoder and configured to output a level signal corresponding to the encoder output values; a first controlled current source coupled with the safety chain and configured to output a first current corresponding to a current flowing through the safety chain; and a second controlled current source coupled with the processor and configured to output a second current corresponding to the level signal; a control unit coupled with the first controlled current source and the second controlled current source and configured to perform corresponding safety protection operations in response to the first current and the second current.

Optionally, in the above safety protection system, the control unit comprises: a safety triggering mechanism coupled with an output end of the first controlled current source and configured to cut off a power supply from a main power supply to the escalator in response to a current output by the first controlled current source when at least one of the plurality of protective switches is in an open state; a microcontroller coupled with an output end of the second controlled current source.

Optionally, in the above safety protection system, the safety protection system further comprises a signal transmission cable, the output end of the first controlled current source and the output end of the second controlled current source are coupled with the safety triggering mechanism and the microcontroller, respectively, via the signal transmission cable.

Optionally, in the above safety protection system, the control unit further comprises an analog-to-digital converter coupled with the output end of the second controlled current source via the signal transmission cable, the analog-to-digital converter is configured to convert an analog voltage signal corresponding to the second current into a digital signal and output the digital signal to the microcontroller.

Optionally, in the above safety protection system, the safety triggering mechanism is a relay.

### DESCRIPTION OF THE DRAWINGS

The above and/or other aspects and advantages of the present application will be more clearly and easily understood from the following description of various aspects in conjunction with the accompanying drawings, in which the same or similar elements are designated by the same reference numerals. The accompanying drawings include:

FIG. 1 is a schematic diagram of a typical safety protection system for an escalator.

FIG. 2 is a schematic diagram of a safety protection system for an escalator according to some embodiments of the present application.

### DETAILED DESCRIPTION

The present application is described more fully below with reference to the accompanying drawings, in which illustrative embodiments of the application are illustrated. However, the present application may be implemented in different forms and should not be construed as limited to the embodiments presented herein. The presented embodiments are intended to make the disclosure herein comprehensive and complete, so as to more comprehensively convey the protection scope of the application to those skilled in the art.

In this specification, terms such as “comprising” and “including” mean that in addition to units and steps that are directly and clearly stated in the specification and claims, the technical solution of the application does not exclude the presence of other units and steps that are not directly and clearly stated in the specification and claims.

Unless otherwise specified, terms such as “first” and “second” do not indicate the order of the units in terms of time, space, size, etc., but are merely used to distinguish the units.

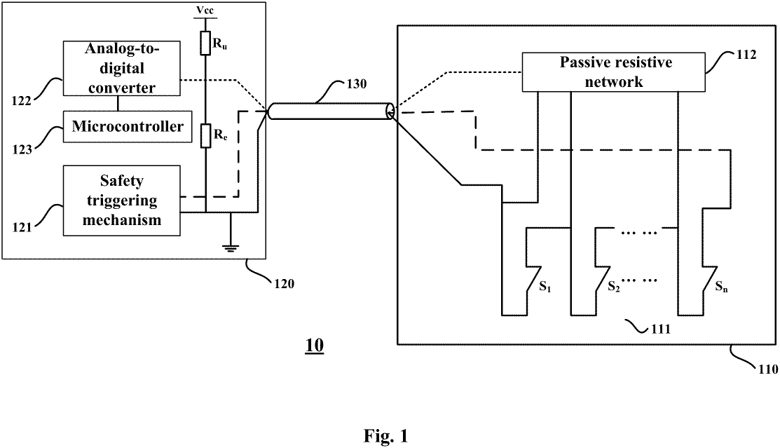

FIG. 1 is a schematic diagram of a typical safety protection system for an escalator.

A safety protection system 10 shown in FIG. 1 includes a safety chain device 110, a control unit 120 and a signal transmission cable 130.

The safety chain device 110 includes a safety chain 111 composed of protective switches S₁-Sₙ connected in series with each other. Each protective switch is associated with one of a plurality of drive chains and is in a normally closed state to form a current loop. When the drive chain is broken, the corresponding protective switch will be switched from a closed state to an open state, so that no more current will pass through the safety chain 111. As shown in FIG. 1, the safety chain device 110 also includes a passive resistive network 112 that is connected to the protective switches in the safety chain 111. When on-off states of the protective switches S₁-Sₙ change, the equivalent resistance of the passive resistive network 112 changes as well.

Continuing with FIG. 1, the safety chain device 110 is connected with the control unit 120 through the signal transmission cable 130. The signal transmission channels provided by the signal transmission cable 130 include a first transmission channel CH1 (shown as a sparse dashed line) and a second transmission channel CH2 (shown as a dense dashed line).

As shown in FIG. 1, the safety chain device 110 is coupled with a safety triggering mechanism 121 in the control unit 120 via the first transmission channel CH1. The safety triggering mechanism 121 can be, for example, a relay or switching element connected between a main power supply and a drive motor of the escalator. When the protective switches S₁-Sₙ are all in a closed state, a current signal is transmitted to the safety triggering mechanism 121 via the first transmission channel CH1, and under the action of this current signal, the safety triggering mechanism 121 remains closed to connect the drive motor of the escalator with the main power supply. On the other hand, when at least one of the protective switches S₁-Sₙ is in an open state, no more current signal is transmitted to the safety triggering mechanism 121 via the first transmission channel CH1. At this time, the safety triggering mechanism 121 will switch to a disconnected state, thus disconnecting an electrical connection between the drive motor and the main power supply, and the escalator will stop running. When the signal transmission cable 130 is long, the noise introduced may create a false trigger signal at the safety triggering mechanism 121.

Continuing with FIG. 1, an output end of the passive resistive network 112 is connected to a common end of voltage divider Rᵤ and Rₑ via the second transmission channel CH2, an analog-to-digital converter 122 in the control unit 120 samples a voltage signal from this common end, and a digital signal obtained after analog-to-digital conversion is output to a microcontroller 123. Since the amplitude represented by this digital signal is related to the equivalent resistance of the passive resistive network 112, the microcontroller 123 can determine or locate the position of the protective switch in the open state in the safety chain 111 according to the amplitude of the digital signal. When the signal transmission cable 130 is long, large noise may be introduced. If the noise is superposed with a current signal output by the passive resistive network 112, the digital signal output by the analog-to-digital converter 122 will be distorted. The microcontroller 123 will not be able to accurately determine the position of the protective switch in the open state in the safety chain 111 according to this signal.

In addition, the equivalent resistance of the above passive resistive network is non-linear, which makes it difficult for the microcontroller 123 to determine the position of the protective switch in the open state in the safety chain 111 for certain resistance points.

Further, in the above safety protection system, the number of the protective switches that can be detected is limited by the resolution of the analog-to-digital converter and the non-linear characteristics of the equivalent resistance, making it difficult to expand as needed.

For each of the plurality of protective switches, it can be in a closed state or an open state, so there are multiple combinations of states for the plurality of protective switches (e.g., n protective switches have 2ⁿ combinations of states). In some embodiments of the present application, the resistive network encoder coupled with the safety chain is utilized to detect the multiple combinations of states of the protective switches. In particular, the resistive network encoder has a plurality of encoder output values, and each encoder output value corresponds to one of the combinations of states. A correspondence of the output values to the combinations of states can be used to determine the position of the protective switch in the open state in the safety chain. Optionally, the encoder output values are processed by the processor and output in the form of digital signal.

In some embodiments of the present application, a controlled current source (e.g., a current-controlled current source or a voltage-controlled current source) is utilized to suppress or eliminate noise introduced by the signal transmission cable. In one example, the anti-interference capability of the signal is improved by adding a controlled current source between the output end of the safety chain and the signal transmission cable. In another example, the anti-interference capability of the signal is improved by adding a controlled current source between the output end of the processor and the signal transmission cable.

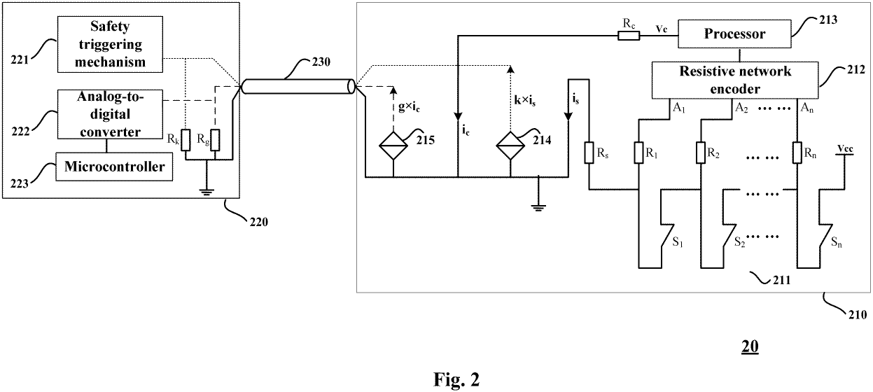

FIG. 2 is a schematic diagram of a safety protection system for an escalator according to some embodiments of the present application.

A safety protection system 20 shown in FIG. 2 includes a safety chain device 210, a control unit 220 and a signal transmission cable 230.

Referring to FIG. 2, the safety chain device 210 includes a safety chain 211, a resistive network encoder 212, a processor 213, a first controlled current source 214 and a second controlled current source 215.

The safety chain 211 includes protective switches S₁-Sₙ connected in series with each other, one end of which is connected to a power supply Vcc and the other end of which is grounded and connected to an input end of the first controlled current source 214 via a resistor Rs. Each protective switch is in a closed state when the associated drive chain is working normally, a constant current iₛ is flowing from the safety chain 211 to the first controlled current source 214 at this time. On the other hand, when the drive chain is abnormal, the corresponding protective switch is switched from a closed state to an open state, and no more current flows to the first controlled current source 214 at this time.

Exemplarily, the first controlled current source 214 may be a current amplifier that amplifies the input current by a factor of k and then outputs it. In the safety chain device shown in FIG. 2, when the protective switches S₁-Sₙ are all in a closed state, the input current of the first controlled current source 214 is iₛ, and accordingly, the output current of the first controlled current source 214 is kxiₛ. When one or more of the protective switches S₁-Sₙ are in an open state, the input current of the first controlled current source 214 is 0, and accordingly, the output current of the first controlled current source 214 is also 0. That is, the output current of the first controlled current source 214 is a binary output quantity.

The resistive network encoder 212 is coupled with the safety chain 211. Exemplarily, as shown in FIG. 2, the resistive network encoder 212 contains a plurality of input ends A₁-Aₙ, which constitute a plurality of pairs of input ends. Each pair of input ends is coupled to both ends of one of the protection switches of the safety chain 211 to sample the state (closed or open) of the protective switch. Taking the situation shown in FIG. 2 as an example, input ends A₁ and A₂ form a pair of input end groups that are connected to both ends of protective switch S₁ via resistors R₁ and R₂, respectively, and input ends A₂ and A₃ form another pair of input end groups that are connected to both ends of protective switch S₂ via resistors R₂ and R₃, respectively ......, for the other protective switches, and so on.

The resistive network encoder 212 has a plurality of encoder output values, and each encoder output value corresponds to one of the combinations of states of the plurality of protective switches. Taking n protective switches as an example, the number of output values may be 2ⁿ. The encoder output values of the resistive network encoder 212 are sent to the processor 213, which processes it and outputs it in the form of a digital signal (represented by a level signal V_{c} in FIG. 2).

Continuing with FIG. 2, the processor 213 is connected to the second controlled current source 215 via a resistor Rc. Exemplarily, the second controlled current source 215 may be a current amplifier that amplifies the input current by a factor of g and outputs it. In the safety chain device shown in FIG. 2, the level signal V_{c} is converted to a current signal i_{c} as the input current of the second controlled current source 215, and accordingly, the output current of the second controlled current source 215 is gxi_{c}. For one of the combinations of states of the protective switches S₁-Sₙ, the resistive network encoder 212 will output the corresponding encoder output value, which is processed by the processor 213 and then outputs the corresponding level signal V_{c}. That is, the input and output currents of the second controlled current source reflect the combinations of states of the plurality of protective switches and can therefore be used to determine the position of the protective switch in the open state in the safety chain.

Optionally, the processor 213 can also be used to implement some intelligent functions, such as real-time analysis of the states of the protective switches.

Referring to FIG. 2, the safety chain device 210 is connected with the control unit 220 via the signal transmission cable 230. Specifically, the output end of the first controlled current source 214 is grounded via the signal transmission cable 230 and resistor Rₖ (this signal transmission path is indicated by a dense dashed line in the figure), and the output end of the second controlled current source 215 is grounded via the signal transmission cable 230 and resistor R_{g} (this signal transmission path is indicated by a sparse dashed line in the figure).

As shown in FIG. 2, the control unit 220 comprises a safety triggering mechanism 221, an analog-to-digital converter 222 and a microcontroller 223, wherein the safety triggering mechanism 221 is connected with the output end of the first controlled current source 214 and the analog-to-digital converter 222 is connected with the output end of the second controlled current source 215.

The safety triggering mechanism 221 may for example be a relay or a switching element. When the protective switches S₁-Sₙ are all in the closed state, the output current of the first controlled current source 214 is kxiₛ, and under the action of this current signal, the safety triggering mechanism 221 remains closed to connect the drive motor of the escalator with the main power supply. On the other hand, when one or more of the protective switches S₁-Sₙ is in the open state, the output current of the first controlled current source 214 is 0. At this time, the safety triggering mechanism 221 is in the open state, and the main power supply stops supplying power to the drive motor, so that the escalator stops running.

Continuing with FIG. 2, the analog-to-digital converter 222 samples a voltage signal from the resistor R_{g}, the voltage signal is output to the microcontroller 223 in the form of a digital signal after analog-to-digital conversion. As mentioned above, the output current of the second controlled current source reflects the combinations of states of the plurality of protective switches, so the microcontroller 223 can determine the position of the protective switch in the open state in the safety chain and generate the corresponding safety protection operation command accordingly.

Those skilled in the art will appreciate that the various illustrative logical blocks, modules, circuits, and algorithm steps described herein may be implemented as electronic hardware, computer software, or combinations of both.

To demonstrate this interchangeability of hardware and software, various illustrative components, blocks, modules, circuits, and steps have been described above generally in terms of their functionality. Whether such functionality is implemented in hardware or software depends on the particular application and design constraints imposed on the overall system. Those skilled in the art may implement the described functionality in varying ways for the particular application. However, such implementation decisions should not be interpreted as causing a departure from the scope of the present application.

Although only a few of the specific embodiments of the present application have been described, those skilled in the art will recognize that the present application may be embodied in many other forms without departing from the spirit and scope thereof. Accordingly, the examples and embodiments shown are to be regarded as illustrative and not restrictive, and various modifications and substitutions may be covered by the application without departing from the spirit and scope of the application as defined by the appended claims.

The embodiments and examples presented herein are provided to best illustrate embodiments in accordance with the present technology and its particular application, and to thereby enable those skilled in the art to implement and use the present application. However, those skilled in the art will appreciate that the above description and examples are provided for convenience of illustration and example only. The presented description is not intended to cover every aspect of the application or to limit the application to the precise form disclosed.

What is claimed is:

1. A safety chain device for an escalator, characterized in that, comprising:
a safety chain including a plurality of protective switches connected in series, each of the protective switches is configured to switch from a first state to a second state in the event of abnormal operation of a respective corresponding drive chain;
a resistive network encoder coupled with the safety chain and having a plurality of encoder output values, each of the encoder output values corresponds to one of combinations of states of the plurality of protective switches;
a processor coupled with the resistive network encoder and configured to output a level signal corresponding to one of the encoder output values;
a first controlled current source coupled with the safety chain and configured to output a first current corresponding to a current flowing through the safety chain; and
a second controlled current source coupled with the processor and configured to output a second current corresponding to the level signal.

2. The safety chain device of claim 1, wherein the first state and the second state are a closed state and an open state respectively.

3. The safety chain device of claim 1, wherein ends of the safety chain are coupled to a power supply and an input end of the first controlled current source respectively.

4. The safety chain device of claim 1, wherein the resistive network encoder comprises a plurality of paired input ends, and each of the paired input ends is coupled to both ends of one of the plurality of protective switches.

5. The safety chain device of claim 1, wherein the first controlled current source and the second controlled current source are current-controlled current sources.

6. The safety chain device of claim 5, wherein the first controlled current source is configured to output a current k times the current flowing through the safety chain when the plurality of protective switches are all in the closed state and to output a zero current when at least one of the plurality of protective switches is in the open state.

7. The safety chain device of claim 5, wherein output ends of the first controlled current source and the second controlled current source are coupled with an external device via a signal transmission cable.

8. The safety chain device of claim 1, wherein the processor is further configured to analyze the states of the protective switches in real time.

9. A safety protection system for an escalator, characterized in that, comprising:
a safety chain device comprising:
a safety chain including a plurality of protective switches coupled in series, each protective switch is configured to switch from a first state to a second state in the event of abnormal operation of a respective corresponding drive chain;
a resistive network encoder having a plurality of encoder output values, each of the encoder output values corresponds to one of combinations of states of the plurality of protective switches;
a processor coupled with the resistive network encoder and configured to output a level signal corresponding to one of the encoder output values;
a first controlled current source coupled with the safety chain and configured to output a first current corresponding to a current flowing through the safety chain; and
a second controlled current source coupled with the processor and configured to output a second current corresponding to the level signal;
a control unit coupled with the first controlled current source and the second controlled current source and configured to perform corresponding safety protection operations in response to the first current and the second current.

10. The safety protection system of claim 9, wherein the first state and the second state are a closed state and an open state respectively.

11. The safety protection system of claim 10, wherein the control unit comprises:
a safety triggering mechanism coupled with an output end of the first controlled current source and configured to cut off a power supply from a main power supply to the escalator in response to a current output by the first controlled current source when at least one of the plurality of protective switches is in the open state;
a microcontroller coupled with an output end of the second controlled current source.

12. The safety protection system of claim 10, wherein both ends of the safety chain are coupled to a power supply and an input end of the first controlled current source respectively.

13. The safety protection system of claim 10, wherein the resistive network encoder comprises a plurality of paired input ends, and each of the paired input ends is coupled to both ends of one of the plurality of protective switches.

14. The safety protection system of claim 10, wherein the first controlled current source and the second controlled current source are current-controlled current sources.

15. The safety protection system of claim 14, wherein the first controlled current source is configured to output a current k times the current flowing through the safety chain when the plurality of protective switches are all in the closed state and to output a zero current when at least one of the plurality of protective switches is in the open state.

16. The safety protection system of claim 11, wherein further comprising a signal transmission cable, the output end of the first controlled current source and the output end of the second controlled current source are coupled with the safety triggering mechanism and the microcontroller, respectively, via the signal transmission cable.

17. The safety protection system of claim 16, wherein the control unit further comprises an analog-to-digital converter coupled with the output end of the second controlled current source via the signal transmission cable, the analog-to-digital converter is configured to convert an analog voltage signal corresponding to the second current into a digital signal and output the digital signal to the microcontroller.

18. The safety protection system of claim 10, wherein the safety triggering mechanism is a relay.
